(19) United States
(12) Patent Application Publication
(10) Pub. No.: US 2007/0268430 A1
(43) Pub. Date: Nov. 22, 2007

(54) TRANSFLECTIVE LCD DISPLAY FOR GROUND VEHICLES

(76) Inventors: James R. Pierce, Cumming, GA (US); Eric H. Walker, Suwanee, GA (US); John A. Wahl, Duluth, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 11/419,151

(22) Filed: May 18, 2006

(51) Int. Cl. G02F 1/1335

(52) U.S. Cl. 349/114

(57) ABSTRACT

A transflective display device for ground vehicles, such as police, fire and ambulance vehicles, has display electronics and a transflective liquid crystal display (LCD). The backlight lamp of the transflective LCD is brighter than those of common transmissive LCDs to facilitate viewing in the changing light conditions experienced by such vehicles.

### BACKGROUND OF THE INVENTION

1. Field of the Invention

The present invention relates generally to electronic displays and, more specifically, to displays used in vehicles.

2. Description of the Related Art

The liquid crystal display (LCD) screen is the most common type of display screen for computing and communication devices in use today and is particularly suitable for mobile devices, such as laptop computers, personal digital assistants (PDAs) and telephones, because it is generally lighter in weight and more rugged, space-efficient and power-efficient than a display based upon alternative technologies. LCDs are commonly backlit by a lamp built into the display housing to enhance readability in dim light. An LCD that can be backlit is referred to as “transmissive” because the light emitted by the lamp is transmitted through the screen to the viewer's eyes.

Transmissive LCDs are difficult to view in bright sunlight or other bright conditions because bright light tends to produce a washed-out effect or reduced-contrast effect. Fully reflective LCDs that have no backlighting do not suffer from this problem, as they reflect all of the ambient light. Nevertheless, fully reflective LCDs are not used in commercially available laptop computer and other portable devices because it is desirable for such devices to be viewable under a wide range of light conditions, including dim light.

A compromise solution has been to provide a transmissive LCD with a very bright backlight lamp. Whereas a typical transmissive LCD may have a lamp with a brightness of 200-400 nit (candela per square meter), LCDs having lamp brightnesses on the order of 1,000 nit have been developed for laptop computers and similar devices intended for use both indoors in dim light and outdoors in bright sunlight. Such high-brightness transmissive LCDs are generally bulkier, less economical and less power-efficient than the standard transmissive LCDs used in the vast majority of laptop computers. Consequently, their use has largely been confined to military and aerospace applications, such as aircraft instrument panels, where performance is of greater concern than low cost.

LCDs that mix transmitted backlight with reflected ambient light are known as “transflective” (also sometimes referred to as “transreflective”). A transflective LCD that passes or transmits a high percentage of the backlight while reflecting some of the ambient light is a good compromise between a transmissive LCD and a reflective LCD because it is highly readable in both dim and bright light. The brightness of transflective LCDs as measured off the screen in darkness, i.e., due entirely to backlighting, is typically on the order of 200-400 nit, as in a typical consumer-grade transmissive LCD. In fact, some manufacturers have retrofitted or modified commercial-off-the-shelf transmissive LCDs by installing partially reflective, partially transmissive films between the backlight lamp and the LCD. Other methods for making transflective LCDs include thin-film vacuum deposition of a material such as indium-tin oxide directly on the rear of the LCD.

Police, fire, ambulance and other first responder personnel have found it difficult to clearly view the (transmissive) LCDs of the laptop computers installed in their vehicles in the rapidly changing light conditions they often encounter. For example, while enroute to an emergency scene, the vehicle may quickly move between the relative brightness of a sunny day and darkness of a tunnel or underpass. Indeed, at least momentarily, part of the screen may be covered in shadow while part remains in bright sunlight. It is critical that first responders be able to clearly view their computer screens at all times while enroute to or parked at an emergency scene. As the LCD is generally fixedly mounted in the vehicle, either as part of a laptop computer or as an independent display, the user cannot simply reorient the screen to a more readable position or change his or her viewing position, as a user sitting at an office desk might be able to do. The rapidly changing light conditions at dusk and dawn also cause viewing difficulty.

Accordingly, it would be desirable to provide an improved LCD screen for emergency first responder vehicles and other ground vehicles. It is to such an apparatus and method that the present invention is primarily directed.

### SUMMARY OF THE INVENTION

Briefly described, in a preferred form, the present invention relates to a high-brightness transflective display device for a ground vehicle. The display device has display electronics and a transflective liquid crystal display (LCD) coupled to the display electronics. The backlight lamp of the transflective LCD preferably has a brightness selected such that it causes the display device to have a brightness (as measured in ambient darkness, i.e., brightness due entirely to the backlighting) greater than about 500 nit (candela per square meter), which is much brighter than most commercially available transmissive LCDs. Still more preferably, the LCD has a brightness greater than about 750 nit. The high-brightness transflective display device can be made economically by modifying a commercial-off-the-shelf transmissive LCD display device, adding a transmissive-reflective coating or film, and replacing the backlight lamp with a high-brightness backlight lamp.

The above-described transflective display device can be installed or otherwise disposed in an emergency first responder vehicle, such as a police, fire or emergency medical service (i.e., ambulance) vehicle. Alternatively, it can be used in a commercial vehicle, such as a delivery truck or utility company service truck. The unusually bright transflective display is easily viewable in the changing light conditions experienced by such vehicles. Advantageously, this new display device provides excellent performance at a reasonable cost.

### BRIEF DESCRIPTION OF THE DRAWINGS

FIG. 1 is a perspective view of a high-brightness transflective display device, according to a preferred illustrative form of the present invention.

FIG. 2 is a cross-sectional view of the high-brightness transflective display device of FIG. 1, taken on line 2-2 of FIG. 1.

FIG. 3 is a perspective view of the high-brightness transflective display device of FIG. 1, shown installed in a police vehicle.

### DETAILED DESCRIPTION

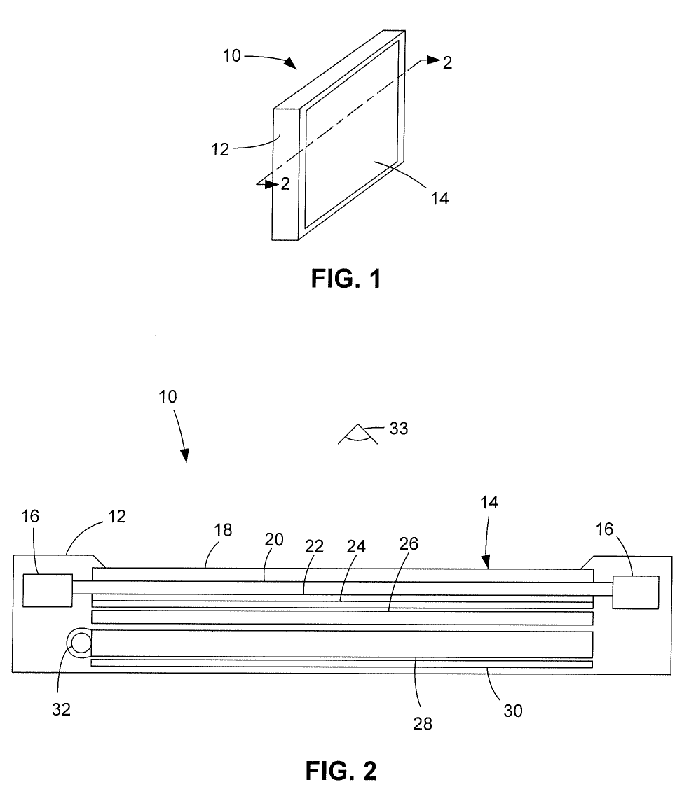

As illustrated in FIGS. 1-2, a high-brightness transflective display device 10 has a shape similar to that of conventional display devices included in laptop computers, flat-screen computer monitors, and the like. As such, display device 10 includes a relatively thin-profile rectangular housing 12 in which are mounted a transflective liquid crystal display (LCD) 14 and associated display electronics 16.

LCD 14 comprises, in layered arrangement, a cover glass 18, a liquid crystal panel 20, a partially transmissive, partially reflective (transflective) film 22, a brightness-enhancing film 24, a diffuser 26, an edge-lit backlight or light guide 28, and a reflective film 30. In a manner analogous to a one-way mirror, transflective film 22 reflects a portion of the ambient light that may be incident upon cover glass 18 and transmits another portion of that ambient light. A high-brightness backlighting lamp 32, such as a cold cathode fluorescent lamp (CCFL), is optically coupled to light guide 28. The brightness of backlighting lamp 32 causes LCD 14 to have a measurable brightness (as measured off cover glass 18 from an observation point 33 in ambient darkness) greater than about 500 nit (candela per square meter). In an especially preferred form, LCD 14 has a brightness greater than about 750 nit. A brightness of about 900 nit is believed to be optimal. A lamp with much greater brightness (e.g., greater than about 1,500 nit) may consume excessive power and generate excessive heat. With the exception of the brightness of backlighting lamp 32, the arrangement, structure and function of the individual above-referenced elements shown in FIG. 2 are conventional, well known in the art, and therefore not described in further detail herein.

Transflective LCD 14 can be made economically by modifying a commercial-off-the-shelf (COTS) transmissive LCD device. For example, film 22 or, alternatively, a transmissive-reflective coating (e.g., vacuum-deposited indium-tin oxide, not shown) can be added to the COTS device, and the manufacturer's original backlighting lamp (typically 200-400 nit for a consumer-grade device) can be replaced with the above-described high-brightness backlighting lamp 32.

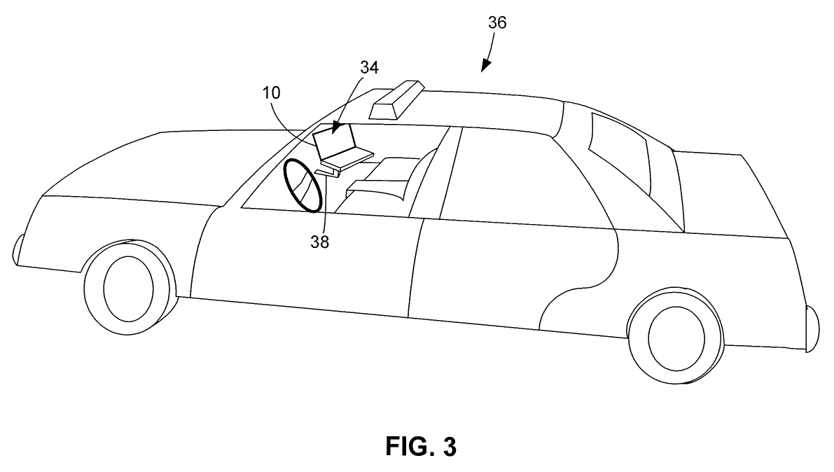

As illustrated in FIG. 3, high-brightness transflective display device 10 can be included in or otherwise coupled to a laptop computer 34 or similar device. Laptop computer 34 (and thus its display device 10) can be mounted in a conventional manner in a ground vehicle, such as a police vehicle 36, by a suitable mounting means such as an adjustable bracket 38. Although a police vehicle 36 is shown, in other embodiments of the invention the ground vehicle can be another type of emergency first responder vehicle, such as a fire engine or ambulance, another type of official government vehicle, or a commercial vehicle such as a utility company service truck or a delivery vehicle. Although laptop computer 34 is shown mounted in the conventional orientation in police vehicle 36, in which the police officer (driver) can conveniently use laptop computer 34 while seated in the driver's seat, in other embodiments of the invention display device 10 or a device in which it is included can be mounted in any other suitable orientation.

The unusually bright transflective display device 10 is easily viewable by the vehicle occupant(s) in the changing light conditions experienced by such vehicles. It remains viewable even if part of LCD 14 is in shadow and part is in bright sunlight, as often occurs as such vehicles are enroute. It also remains viewable during the problematic transition times of day of dusk and dawn.

It will be apparent to those skilled in the art that various modifications and variations can be made to this invention without departing from the spirit or scope of the invention. Thus, it is intended that the present invention covers the modifications and variations of this invention provided that they come within the scope of any claims and their equivalents. With regard to the claims, no claim is intended to invoke the sixth paragraph of 35 U.S.C. Section 112 unless it includes the term “means for” followed by a participle.

What is claimed is:

1. A liquid crystal display (LCD) device for use in a ground vehicle, the LCD device comprising:
a transflective LCD comprising a transmissive-reflective layer and a backlight lamp causing the LCD device to have a brightness of at least about 500 nit; and
display electronics coupled to the transflective LCD;
wherein in use in the ground vehicle the LCD has good readability over a wide variety of ambient light conditions.

2. An LCD device as claimed in claim 1, wherein the backlight lamp causes the LCD device to have a brightness of at least about 750 nit.

3. An LCD device as claimed in claim 1, wherein the backlight lamp causes the LCD device to have a brightness of about 900 nit.

4. An LCD device as claimed in claim 1, wherein a consumer-grade transmissive LCD is combined with a transmissive-reflective layer and relatively high-brightness backlight lamp.

5. An LCD device as claimed in claim 1, wherein the ground vehicle is a first responder vehicle.

6. A display device for a ground vehicle, comprising:
display electronics; and
a transflective liquid crystal display (LCD) coupled to the display electronics, the LCD having a transmissive-reflective material and a backlight lamp.

7. The display device claimed in claim 6, further comprising means for mounting the display device in a ground vehicle.

8. The display device claimed in claim 6, wherein the backlight lamp causes the display device to have a brightness greater than about 500 nit (candela per square meter).

9. The display device claimed in claim 8, wherein the backlight lamp causes the display device to have a brightness greater than about 750 nit (candela per square meter).

10. A method for disposing a display device in a ground vehicle, comprising:
providing a display device having display electronics and a transflective liquid crystal display (LCD) coupled to the display electronics, the LCD having a transmissive-reflective material and a backlight lamp; and
disposing the display device in a ground vehicle.

11. The method claimed in claim 10, wherein the disposing step comprises mounting the display device in the ground vehicle in an orientation viewable by an occupant of the vehicle.

12. The method claimed in claim 11, wherein the disposing step comprises disposing the display device in an emergency first responder vehicle.

13. The method claimed in claim 12, wherein the backlight lamp causes the display device to have a brightness greater than about 500 nit.

14. The method claimed in claim 13, wherein the backlight lamp causes the display device to have a brightness greater than about 750 nit.
